(19) United States
(12) Patent Application Publication
(10) Pub. No.: US 2022/0198040 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yuji YONEDA, Kanagawa (JP)

(73) Assignee: FUJIFILM Business Innovation Corp., Tokyo (JP)

(21) Appl. No.: 17/307,346

(22) Filed: May 4, 2021

(30) Foreign Application Priority Data
Dec. 22, 2020 (JP) 2020-212627

(51) Int. Cl. G06F 21/62; G06F 40/174; G06F 40/186; G06F 3/0481; H04N 1/00

(52) U.S. Cl. CPC G06F 21/629; G06F 40/174; H04N 1/0048; G06F 3/04812; H04N 1/00331; G06F 40/186

(57) ABSTRACT

An information processing apparatus includes a processor configured to perform control for not accepting a collective output command with respect to multiple pieces of business form data having different preset output conditions. Each piece of business form data is obtained by reading a business form having a predetermined item filled in with information.

### CROSS-REFERENCE TO RELATED APPLICATIONS

This application is based on and claims priority under 35 USC 119 from Japanese Patent Application No. 2020-212627 filed Dec. 22, 2020.

### Background

### (i) Technical Field

The present disclosure relates to information processing apparatuses and non-transitory computer readable media.

### (ii) Related Art

Japanese Patent No. 6771906 discloses an information processing apparatus that processes document data. The information processing apparatus includes an input unit, an executing unit, a correcting unit, a storage unit, and a generating unit. The input unit receives document data to be processed and flow-definition document data describing multiple types of processes to be performed on the document data and the processing sequence of the processes. The executing unit executes all the processes in accordance with the processing sequence described in the flow-definition document data. The correcting unit corrects an error in the execution result obtained by the executing unit in accordance with a command from a user. The storage unit executes the processes in the reversed sequence relative to the processing sequence described in the flow-definition document data, generates information such that the processing results obtained as a result of performing the processes are to serve as contents to be corrected by the correcting unit, and stores the information. The generating unit generates new flow-definition document data as a target to be input to the input unit by adding the description for executing the processes according to the information stored in the storage unit to the aforementioned flow-definition document data.

Japanese Unexamined Patent Application Publication No. 5-334059 discloses a method for programming a business operation constituted by a relationship that defines mapping between multiple types of business forms. The business programming method includes a business definition procedure step for describing the structure of the business operation in accordance with an input/output correspondence relationship of a business form group and for defining the procedure of the business operation in accordance with a temporal sequence relationship of the execution of the business forms, an execution-menu generating step for generating an execution menu for controlling the execution of multiple business forms based on the business procedure defined in the definition procedure step, a business-form defining step for defining the structure of each business form in accordance with a description about a format of the business form and a description about processing specifications including calculation and editing of the business form, and an executing step for executing the business-form specifications defined in the business-form defining step based on the execution menu generated in the execution-menu generating step.

Japanese Unexamined Patent Application Publication No. 2008-33646 discloses a business-form generating apparatus that includes a business-form-template-set storage unit, a business-form-template-set selecting unit, a data acquiring unit, a template acquiring unit, a business-form output-setting acquiring unit, a data merging unit, and a business-form output unit. The business-form-template-set storage unit stores a business-form template set constituted of at least one business form template, data-acquisition-command information related to a data acquisition command, at least one piece of business-form output-setting information serving as setting information when a business form is to be output, and output-setting management information that associates the business form template and the business-form output-setting information with each other. Each business form template is constituted of data merge information that defines a location of a business form where business-form format information and acquired data are to be inserted. The business-form-template-set selecting unit selects one business-form template set from multiple business-form template sets stored in the business-form-template-set storage unit. The data acquiring unit acquires data based on the data-acquisition-command information included in the business-form template set. The template acquiring unit acquires the business form template included in the business-form template set. The business-form output-setting acquiring unit acquires business-form output-setting information corresponding to the business form template acquired by the template acquiring unit. The data merging unit generates business form data by performing data merging of the data acquired by the data acquiring unit based on the data merge information of the business form template included in the business-form template set. The business-form output unit outputs the business form data generated by the data merging unit. For each business form template, the business-form output unit outputs the business form data generated by the data merging unit based on a business-form output setting corresponding to the business form template acquired by the business-form output-setting acquiring unit.

### SUMMARY

Business form data obtained as a result of reading a business form having information filled in predetermined items is processed in accordance with predetermined settings. Because business form data is output in a specific output format and is sometimes input to a system, such as a core system, an appropriate output format is set in accordance with the business form. If multiple pieces of business form data with different output formats are collectively output by being bundled into a single group of business form data in response to a collective output command for the multiple pieces of business form data with the different output formats, it may sometimes be difficult for the system at the output destination to process the business form data.

Aspects of non-limiting embodiments of the present disclosure relate to an information processing apparatus and a non-transitory computer readable medium that may prevent business form data in a condition not processable by a system at an output destination from being output thereto in a case where multiple pieces of business form data with different output conditions are displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to perform control for not accepting a collective output command with respect to multiple pieces of business form data having different preset output conditions. Each piece of business form data is obtained by reading a business form having a predetermined item filled in with information.

### BRIEF DESCRIPTION OF THE DRAWINGS

An exemplary embodiment of the present disclosure will be described in detail based on the following figures, wherein:

FIG. 1 schematically illustrates the configuration of a business form system;

FIG. 2 is a diagram for explaining a job rule;

FIG. 3 is a diagram for explaining a job rule set;

FIG. 4 is a diagram for explaining the relationship between job rule sets and jobs;

FIG. 5 is a block diagram illustrating a hardware configuration of an information processing apparatus;

FIG. 6 illustrates an example of an output command screen;

FIG. 7 illustrates an example of an output-condition setting screen;

FIG. 8 illustrates an example of the output command screen;

FIG. 9 illustrates an example of the output command screen; and

FIG. 10 is a flowchart illustrating the flow of information processing executed by the information processing apparatus.

### DETAILED DESCRIPTION

An exemplary embodiment according to the disclosure will be described in detail below with reference to the drawings.

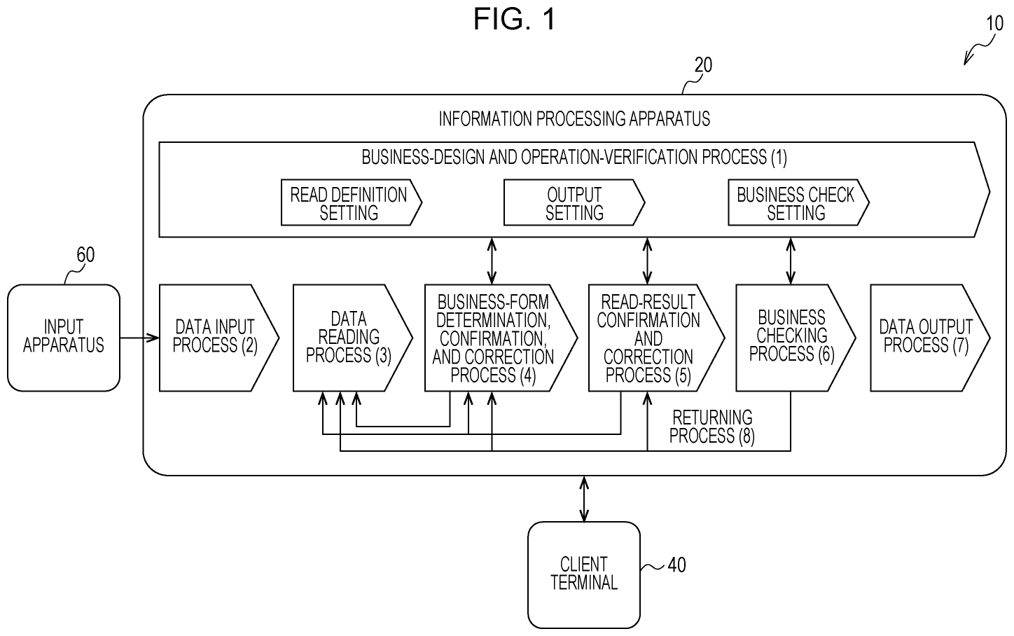

FIG. 1 schematically illustrates the configuration of a business form system 10 according to this exemplary embodiment.

As shown in FIG. 1, the business form system 10 includes an information processing apparatus 20, a client terminal 40, and an input apparatus 60. These apparatuses are connected to a network (not shown), and are communicable with one another via the network. Examples of the network used include the Internet, a local area network (LAN), and a wide area network (WAN).

The information processing apparatus 20 performs optical character recognition (OCR) on image data of multiple documents, including business forms, input via the input apparatus 60, and manages the flow of a sequential process for outputting the OCR result to a predetermined output destination. The specific configuration and operation of the information processing apparatus 20 will be described later.

A business form is a document having information filled in predetermined items. Such a business form may be, but is not limited to, a document having information filled therein for business or transaction, such as a ledger sheet, a slip sheet, an invoice, a bill, or an application form. The items in a business form are, for example, information to be used for business or transaction, and include, but are not limited to, a name, an address, a birthdate, and the current date.

The client terminal 40 transmits various types of OCR-related commands to the information processing apparatus 20. These various types of commands include, for example, a start command for reading information in image data and a command for displaying a read result of information in image data, that is, business form data obtained as a result of reading a business form.

The client terminal 40 also displays a result of the OCR performed by the information processing apparatus 20 in response to the various types of commands received, as well as various types of OCR-related information, such as a notification. The client terminal 40 used may be, for example, a general-purpose computer, such as a server computer or a personal computer (PC). As an alternative to FIG. 1 in which a single client terminal 40 is shown, multiple client terminals 40 may be prepared, such that, for example, the client terminals 40 are used for different processes.

The input apparatus 60 inputs image data to be OCR-processed to the information processing apparatus 20. Examples of the input apparatus 60 include a general-purpose computer, such as a server computer or a PC, and an image forming apparatus having a scanning function, a printing function, and a facsimile function. In addition to the input apparatus 60, the client terminal 40 may also input image data to the information processing apparatus 20.

The following relates to a general description of the business form system 10.

The business form system 10 is a system in which the information processing apparatus 20 performs OCR on image data input via the input apparatus 60 and outputs business form data as an OCR result to a predetermined output destination.

The information processing apparatus 20 manages various processes in the OCR, including a business-design and operation-verification process (1), a data input process (2), a data reading process (3), a business-form determination, confirmation, and correction process (4), a read-result confirmation and correction process (5), a business checking process (6), a data output process (7), and a returning process (8). In this exemplary embodiment, the term “OCR” includes not only a process for simply reading text and symbols from image data, but also post-processing, such as text correction.

The business-design and operation-verification process (1), the data input process (2), the data reading process (3), the business checking process (6), and the data output process (7) as examples of the various types of processes to be managed are executed automatically by the information processing apparatus 20. Furthermore, the business-form determination, confirmation, and correction process (4) and the read-result confirmation and correction process (5) as examples of the various types of processes to be managed are accepted by being input by a user via the client terminal 40. Moreover, the returning process (8) as one of examples of the various types of processes to be managed may sometimes be executed automatically by the information processing apparatus 20 or may sometimes be accepted by being input by the user via the client terminal 40.

The business-design and operation-verification process (1) involves creating job rules including a read definition setting, an output setting, and a business check setting. In the read definition setting, for example, a read range is set as a range in which information in image data is to be read in the data reading process (3). In more detail, for example, the process may involve setting a definition in which an item value is to be read as a value from near the right side of an item to be extracted as a key. In the output setting, for example, output conditions including at least one of an output format, such as a file format, of output data to be output in the data output process (7) and an output destination are set. In the business check setting, for example, a necessary input item in a business form to be detected in the business checking process (6) and a format of an inputtable number of text characters are set.

The data input process (2) involves receiving image data from the input apparatus 60. The received image data is registered as a job serving as a unit executable in the data reading process (3).

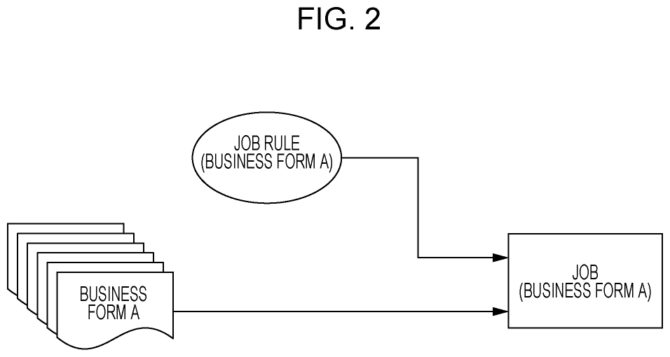

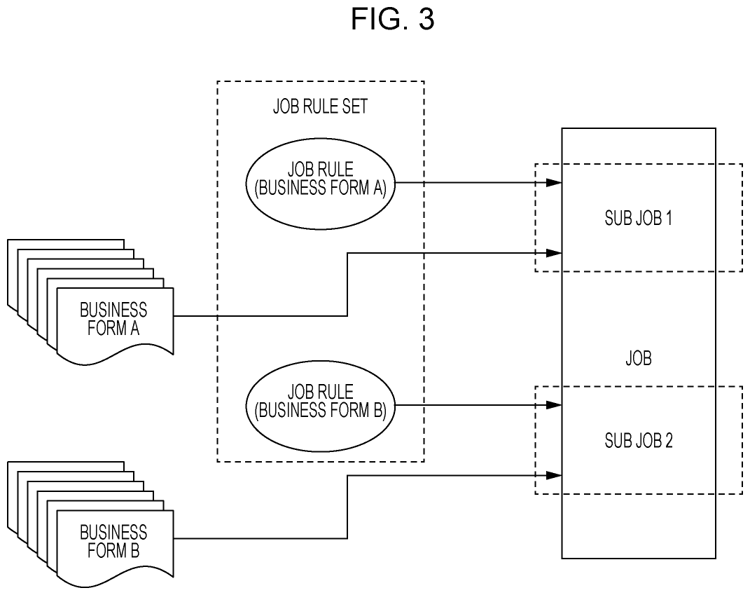

The data reading process (3) involves reading information in the image data within the job by using a job rule for the job to be executed. This job rule is selected by the user from the job rules created in the business-design and operation-verification process (1). For example, this process involves determining a business form (sometimes referred to as “business-form determination” hereinafter) included in the image data within the job and reading the text and symbols within the read range. The job rule to be selected by the user for a single job does not have to be a single job rule. If the user selects multiple job rules for a single job, the image data is processed by using a set containing multiple job rules, that is, a job rule set. In this case, for each business form expressed by the image data, a job rule for the type identified from the multiple job rules is applied in accordance with a type determination result. In a case where a job rule set is used, the process based on each job rule will be referred to as “sub job” hereinafter. A detailed description of a job rule, a job rule set, and a sub job will be provided later with reference to FIGS. 2 and 3.

The business-form determination, confirmation, and correction process (4) involves splitting the image data within the job into records indicating business forms included in the job based on the business-form determination result obtained in the data reading process (3). Subsequently, this process involves displaying the split records and accepting confirmation and correction of the business-form determination by the user.

The read-result confirmation and correction process (5) involves displaying the read result, of the text and symbols within the read range, obtained in the data reading process (3), and accepting confirmation and correction of the read result by the user.

The business checking process (6) involves detecting an error in each preceding process in accordance with the business check setting included in the job rule, selected by the user from the job rules created in the business-design and operation-verification process (1), for the relevant job. The detection result may be presented to the user.

The data output process (7) involves creating business form data by using the output setting included in the job rule, selected by the user from the job rules created in the business-design and operation-verification process (1), for the relevant job, and outputting the created business form data to the predetermined output destination.

The returning process (8) involves returning from the process executed in the OCR to a process previous thereto by one stage or multiple stages. For example, a return command is given by the user via the client terminal 40 while various types of processes, such as the business-form determination, confirmation, and correction process (4) and the read-result confirmation and correction process (5), are being executed. Moreover, for example, a return command is given from the client terminal 40 of a manager in accordance with a result of a checking process performed by the manager between the business checking process (6) and the data output process (7).

In the OCR described above, the business-design and operation-verification process (1) is executed before the data reading process (3) and onward are performed, that is, prior to the operation of the business form system 10. Alternatively, the business-design and operation-verification process (1) may be executed during the operation of the business form system 10 performing the data reading process (3) and onward. For example, a job rule created in the business-design and operation-verification process (1) prior to the operation of the business form system 10 may be appropriately corrected in accordance with a result of the read-result confirmation and correction process (5) during the operation of the business form system 10.

Next, a job rule, a job rule set, and a sub job will be described with reference to FIGS. 2 and 3.

Examples of a job rule include a definition for determining and identifying a target business-form type, a rule related to data correction of an identification result and to error detection when an error occurs, and a definition of output conditions. A rule related to error detection refers to confirmation of monetary consistency, and a definition of output conditions refers to an output format setting and an output destination setting when business form data is to be output. A job rule in the example shown in FIG. 2 indicates a definition and a rule for a process with respect to a type of business form called a business form A. There is a single type of business form to be processed in accordance with a single job rule. As shown in FIG. 2, a job includes image data of an image obtained as a result of reading the business form A as a processing target and a job rule for the business form A.

A job rule set is a bundle of multiple job rules. If a processing target in a job is image data of a business-form image obtained as a result of reading a mixture of multiple types of business forms, a job rule set is used. The information processing apparatus 20 determines which job rule the type of business form identified in a step previous to the OCR is compatible with, and processes the image data of the business form of each type based on the determined job rule. A job rule set in the example shown in FIG. 3 indicates definitions and rules for processes with respect to types of business forms called a business form A and a business form B. In this case, there are two types of image data of business forms to be processed in a single job, such that a process is to be performed on the image data of the business form A and a process is to be performed on the image data of the business form B. The job-rule-based process for the image data of the business form A and the job-rule-based process for the image data of the business form B are each referred to as a “sub job”.

A job rule and a job rule set are both set in the business-design and operation-verification process (1) in the OCR performed in the business form system 10 according to this exemplary embodiment. A job rule and a job rule set may be set in advance or may be arbitrarily set by the user, and may also have multiple job rules and multiple job rule sets, respectively.

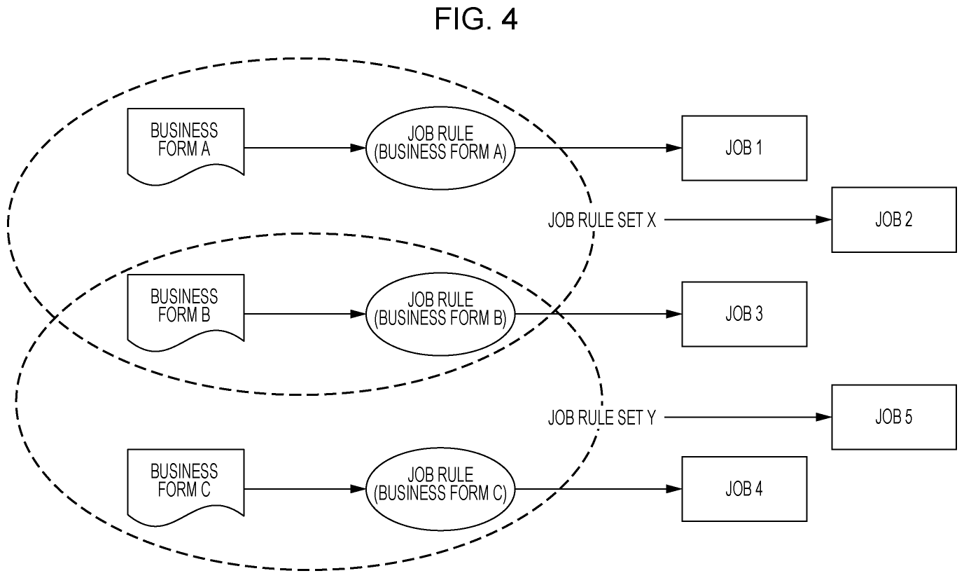

FIG. 4 illustrates the relationships among business forms, job rules, job rule sets, and jobs. As mentioned above, a job rule is a definition and a rule for executing a process on a single type of business form. Therefore, a single job rule is set for a single business form. In FIG. 4, job rules are respectively set for a business form A, a business form B, and a business form C. On the other hand, a job rule set is a bundle of multiple job rules. In the example in FIG. 4, a job rule set X is a processing unit including the job rule for the business form A and the job rule for the business form B. A job rule set Y is also a processing unit including the job rule for the business form B and the job rule for the business form C. In FIG. 4, the job rule for the business form A is set as a job 1, the job rule set X is set as a job 2, the job rule for the business form B is set as a job 3, the job rule set Y is set as a job 5, and the job rule for the business form C is set as a job 4.

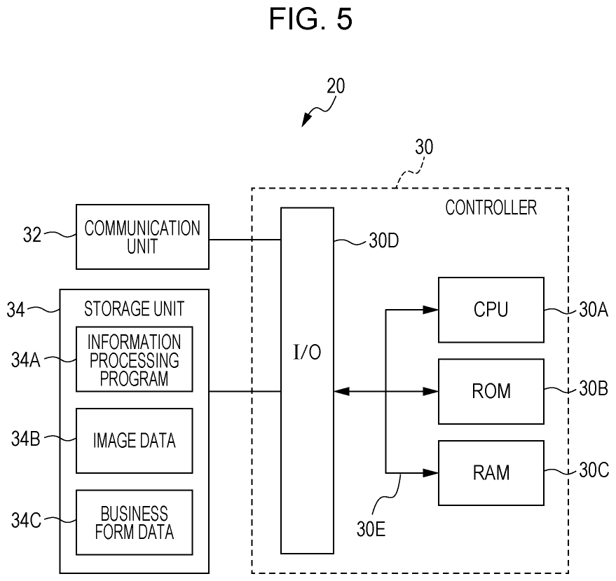

Next, a hardware configuration of the information processing apparatus 20 according to this exemplary embodiment will be described. FIG. 5 is a block diagram illustrating the hardware configuration of the information processing apparatus 20 according to this exemplary embodiment.

As shown in FIG. 5, the information processing apparatus 20 includes a controller 30. The controller 30 includes a central processing unit (CPU) 30A, a read only memory (ROM) 30B, a random access memory (RAM) 30C, and an input/output interface (I/O) 30D. The CPU 30A, the ROM 30B, the RAM 30C, and the I/O 30D are connected to one another by a system bus 30E. The system bus 30E includes a control bus, an address bus, and a data bus. The CPU 30A is an example of a processor.

The I/O 30D is connected to a communication unit 32 and a storage unit 34.

The communication unit 32 is an interface for performing data communication with external apparatuses, such as the client terminal 40 and the input apparatus 60.

The storage unit 34 is constituted of a nonvolatile external storage device, such as a hard disk, and stores therein an information processing program 34A, to be described later, image data 34B input from the input apparatus 60 and obtained as a result of reading a business form, and business form data 34C obtained as a result of executing OCR on the image data 34B in accordance with a job rule. The CPU 30A loads the information processing program 34A stored in the storage unit 34 to the RAM 30C so as to execute the information processing program 34A.

The following description relates to a screen of the client terminal 40 to be used by the user for giving a command for outputting business form data in the data output process (7).

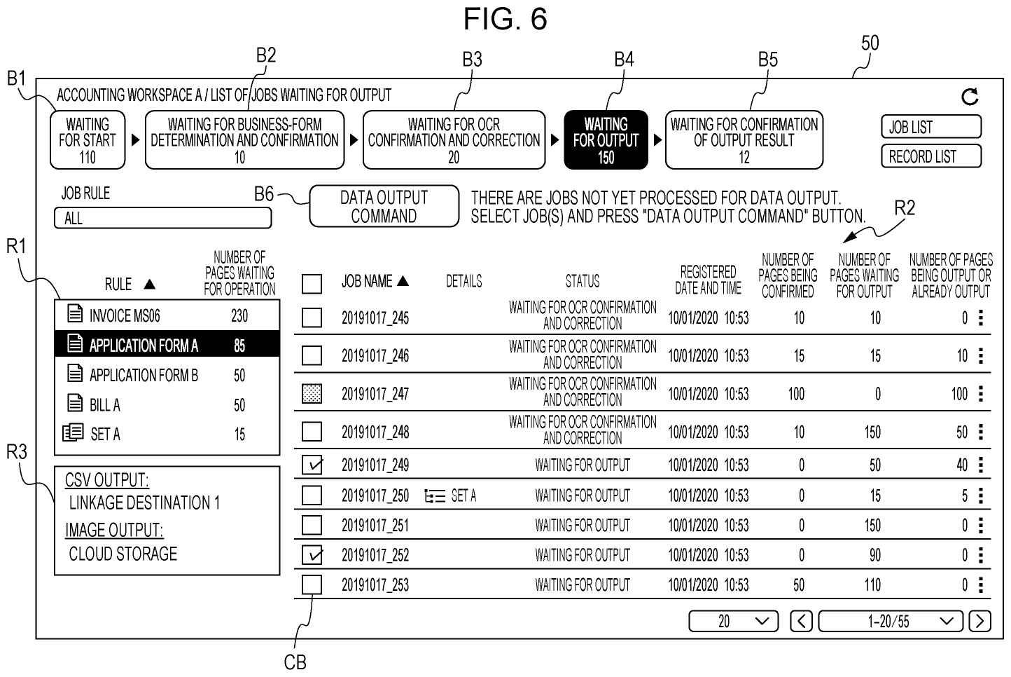

FIG. 6 illustrates an output command screen 50 used for giving a command for outputting business form data. The information processing apparatus 20 functions as, for example, a web server and causes the client terminal 40 to display the output command screen 50. The user uses a web browser of the client terminal 40 to access the information processing apparatus 20 serving as a web server, thereby causing the client terminal 40 to display the output command screen 50 and giving a command for outputting business form data.

As shown in FIG. 6, an upper section of the output command screen 50 displays processing buttons B1 to B5. In accordance with the flow of the processes (1) to (8) described above, the processing buttons B1 to B5 each display a processing status and the number of business forms not yet having undergone the process to be executed in the processing status. When the user presses any one of the processing buttons B1 to B5, specifically, for example, when the user clicks on any one of the processing buttons B1 to B5 by using a mouse, a screen to be used for giving a command for executing the process corresponding to the clicked processing button is displayed on the client terminal 40.

Each of the processing buttons displayed in the example in FIG. 6 is to be used for giving a command for executing a process to be executed in one of five processing statuses, namely, a “waiting for start” processing status, a “waiting for business-form determination and confirmation” processing status, a “waiting for OCR confirmation and correction” processing status, a “waiting for output” processing status, and a “waiting for confirmation of output result” processing status. Moreover, a numerical value indicated below each processing status denotes the number of business forms in the processing status. For example, the processing button B1 in FIG. 6 indicates that there are 110 business forms in the “waiting for start” processing status. The processing button B2 indicates that there are 10 business forms in the “waiting for business-form determination and confirmation” processing status. The processing button B3 indicates that there are 20 business forms in the “waiting for OCR confirmation and correction” processing status. The processing button B4 indicates that there are 150 business forms in the “waiting for output” processing status. The processing button B5 indicates that there are 12 business forms in the “waiting for confirmation of output result” processing status.

The output command screen 50 shown in FIG. 6 is to be displayed on the client terminal 40 when the user clicks on the processing button B4 corresponding to the “waiting for output” processing status.

A job-rule selection region R1 is displayed at the left side of the output command screen 50. The job-rule selection region R1 displays a job rule or a job rule set for each business form in the “waiting for output” processing status, as well as the number of pages waiting for an operation. In the example in FIG. 6, any one of job rules for “invoice”, “application form A”, “application form B”, and “bill A” as the types of business forms and a “set A” as a job rule set including multiple job rules is selectable.

When the user performs an operation for selecting any one of the “invoice”, “application form A”, “application form B”, “bill A” and “set A” options, a list display region R2 at the right side displays a list of information related to business form data corresponding to the selected job rule or job rule set.

In the example in FIG. 6, the “application form A” option is selected, such that the “application form A” is displayed in a highlighted fashion. In this case, the list display region R2 displays pieces of business form data corresponding to the job rule “application form A” among the pieces of business form data in the “waiting for output” processing status.

As shown in FIG. 6, for each piece of business form data, the list display region R2 displays a “job name” item indicating the name of the job, a “details” item indicating the details of the job rule to be applied to the job, a “status” item indicating the processing status of the job, a “registered date and time” item indicating the date and time at which the job is registered in the information processing apparatus 20, a “number of pages being confirmed” item indicating the number of pages being confirmed in the OCR confirmation and correction process, a “number of pages waiting for output” item indicating the number of pages waiting to be output to the output destination of the business form data, and a “number of pages being output or already output” item indicating the number of pages being output or already output to the output destination of the business form data. A checkbox CB is displayed to the left of each job name for selecting a job to be output. As shown in FIG. 6, the checkbox CB for the job having the job name “20191017_247” with “0” as the “number of pages waiting for output” is grayed out, so that a checkmark is not inputtable.

The job with the job name “20191017_250” has “set A” displayed in the “details” item thereof. This indicates that the job rule “application form A” included in the set A as a job rule set is applied to the job with the job name “20191017_250”.

An output command button B6 for giving a command for outputting business form data to an output destination is displayed above the list display region R2 in FIG. 6. When the user clicks on the output command button B6, business form data of a job given a checkmark in the checkbox CB thereof is output to an output destination.

In the example in FIG. 6, checkmarks are input to the checkboxes CB for the job names “20191017_249” and “20191017_252”. Since these jobs have the same job rule “application form A”, when the output command button B6 is clicked, the pieces of business form data of the two jobs given the checkmarks in the checkboxes CB thereof are collectively output to the output destination.

An output condition region R3 for displaying output conditions included a job rule and also for giving a command for changing an output condition is provided below the job-rule selection region R1 in FIG. 6. In the example in FIG. 6, output conditions set in the job rule “application form A” include “linkage destination 1” as an output destination to which business form data is to be output as CSV data and “cloud storage” as an output destination to which business form data is to be output as image data.

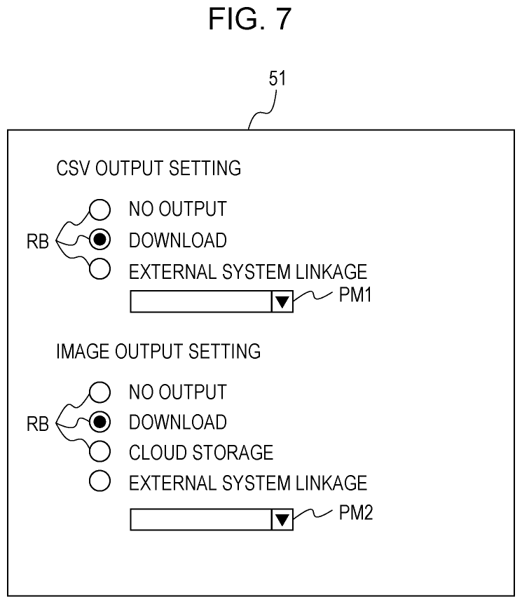

When an area (link) displaying “CSV output” or “image output” is clicked, for example, an output-condition setting screen 51 as shown in FIG. 7 is displayed, such that an output destination for business form data in the CSV format and an output destination for business form data in the image format are settable.

In the example in FIG. 7, an output destination for business form data in the CSV format is selectable by checking any one of radio buttons RB corresponding to “no output”, “download”, and “external system linkage” options. If the “external system linkage” option is selected, a linkage destination is selectable by clicking on a pull-down menu PM1 for selecting an external system.

Furthermore, in the example in FIG. 7, an output destination for business form data in the image format is selectable by checking any one of radio buttons RB corresponding to “no output”, “download”, “cloud storage”, and “external system linkage” options. If the “external system linkage” option is selected, a linkage destination is selectable by clicking on a pull-down menu PM2 for selecting an external system.

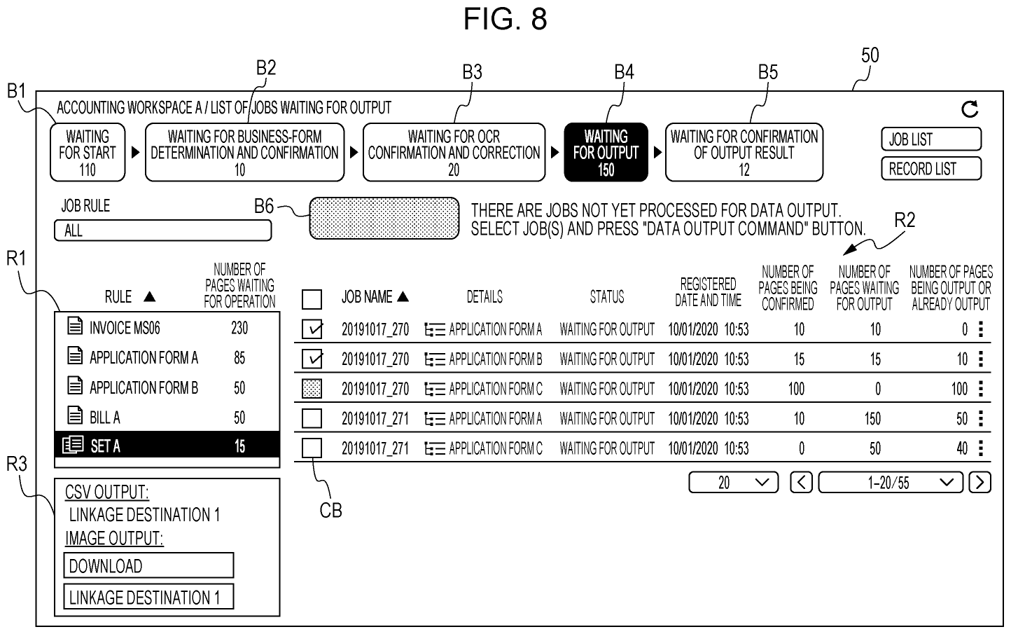

FIG. 8 illustrates a case where the job rule set “set A” is selected in the job-rule selection region R1. In this exemplary embodiment, the “set A” includes three job rules “application form A”, “application form B”, and “application form C”. Thus, the list display region R2 displays a list of sub jobs to which the job rules “application form A”, “application form B”, and “application form C” are to be applied.

The output conditions set for each job rule to be applied to a job given a checkmark in the checkbox CB thereof are displayed in the output condition region R3. In the example in FIG. 6, the output conditions are the same since the job rule “application form A” is applied to all the jobs displayed in the list display region R2. In contrast, in the example in FIG. 8, different job rules are to be applied to the sub jobs, as indicated under the “details” item, sometimes resulting in different output conditions. Therefore, if multiple checkboxes CB are given checkmarks in the list display region R2, the output condition region R3 displays all the output conditions set for the job rules to be applied to the multiple sub jobs given the checkmarks.

For example, as shown in FIG. 8, in a case where a sub job with the job name “20191017_270” and the job rule “application form A” and a sub job with the job name “20191017_270” and the job rule “application form B” are selected, it is assumed that the output destination for business form data in the image format set in the job rule “application form A” is “download” and the output destination for business form data in the image format set in the job rule “application form B” is “linkage destination 1”.

In this case, as shown in FIG. 8, the “download” and “linkage destination 1” options are displayed as the output destinations for business form data in the image format. Moreover, the output destinations are displayed in a highlighted fashion so that it is easily recognizable that the output destinations set in the respective job rules of the multiple selected sub jobs are different. Although the text for “download” and the text for “linkage destination 1” are surrounded by frames in the example in FIG. 8, the highlighting method is not limited to this example.

Furthermore, when sub jobs with different output conditions are selected, there may be a case where business form data in a format not processable by the system at the output destination may be output if a collective output command is allowed.

Thus, when sub jobs with different output conditions are selected, the output command button B6 is grayed out, as shown in FIG. 8, so as not to accept a collective output command.

When any one of the multiple output conditions displayed in the output condition region R3 is selected, the output conditions of the multiple selected sub jobs may be forcibly set to the output condition selected in the output condition region R3. In this case, the display mode of the grayed-out output command button B6 is set back to the normal display mode, thereby transitioning to a state where a collective output command is acceptable.

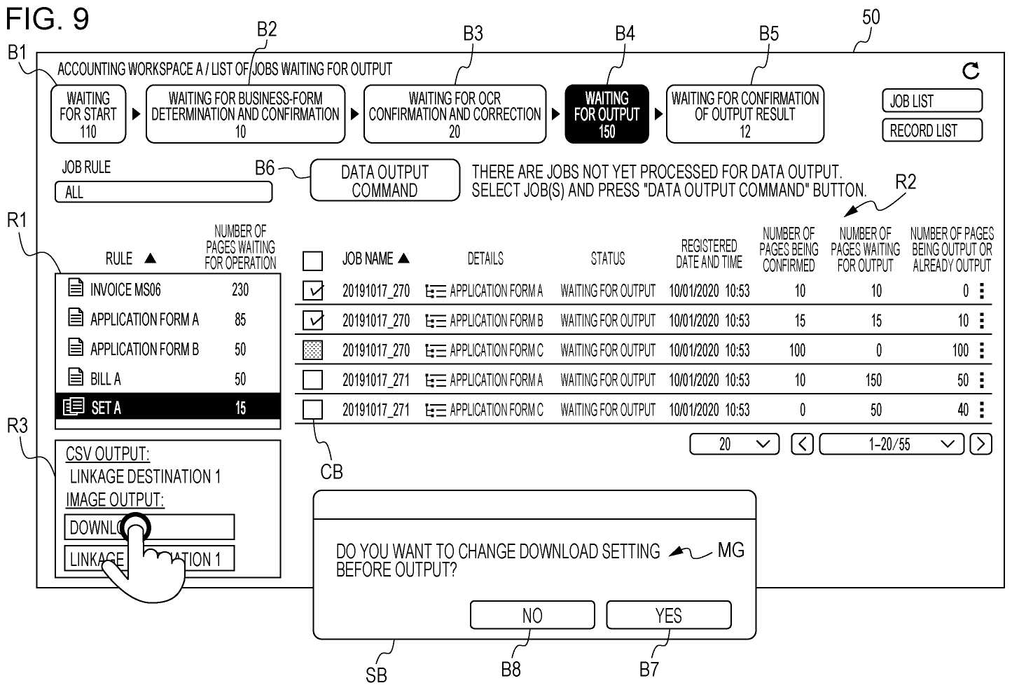

For example, as shown in FIG. 9, of the “download” and “linkage destination 1” options displayed in the output condition region R3, if the “download” option is clicked, a sub screen SB is displayed. In this case, the sub screen SB displays a message MG “Do you want to change download setting before output?”, a button B7 for allowing a change in the setting, and a button B8 for not allowing a change in the setting. If the user clicks on the button B7 for allowing a change in the setting, the output condition for the sub job to which the job rule “application form B” is to be applied and whose output condition is set to “linkage destination 1” is forcibly changed to “download”, and the output command button B6 is set back to the normal mode from the grayed-out mode. Accordingly, even when multiple sub jobs originally with different output destinations are selected, a collective output command becomes possible.

For example, in a case where a sub job with the job name “20191017_270” and the job rule “application form A” and a sub job with the job name “20191017_271” and the job rule “application form C” are selected, if the output destination for business form data in the image format set in the job rule “application form A” is “download” and the output destination for business form data in the image format set in the job rule “application form C” is “download”, a collective output command is possible since the output destinations are the same.

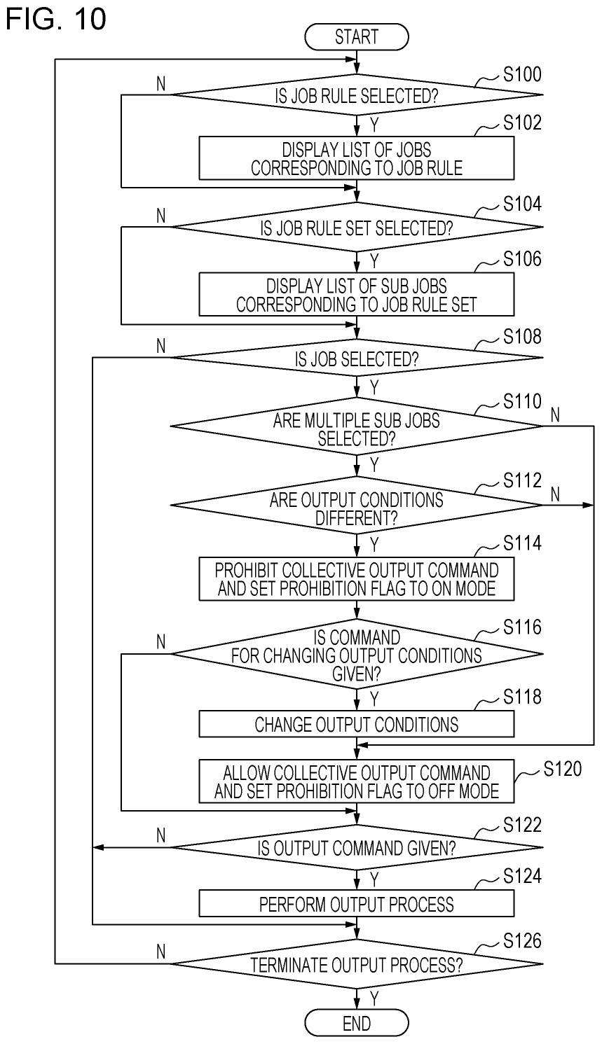

Next, the operation of the information processing apparatus 20 according to this exemplary embodiment will be described. FIG. 10 is a flowchart illustrating the flow of information processing executed in the information processing apparatus 20 according to this exemplary embodiment. The information processing shown in FIG. 10 is executed by the CPU 30A loading the information processing program 34A from the storage unit 34. Moreover, the information processing shown in FIG. 10 is to be executed in the phase of the data output process (7), and is executed when the user gives a command for performing the data output process (7).

If a job rule and a job rule set are not to be distinguished from each other in the following description, they will simply be referred to as a rule. Moreover, if a job and a sub job are not to be distinguished from each other, they will simply be referred to as a job.

In step S100, the CPU 30A determines whether or not a job rule is selected from rules displayed in the job-rule selection region R1. If a job rule is selected, the processing proceeds to step S102. If a job rule is not selected, the processing proceeds to step S104.

In step S102, the CPU 30A causes the list display region R2 to display job-related information corresponding to the job rule selected in step 5100 based on business form data 34C stored in the storage unit 34.

In step S104, the CPU 30A determines whether or not a job rule set is selected from the rules displayed in the job-rule selection region R1. If a job rule set is selected, the processing proceeds to step S106. If a job rule set is not selected, the processing proceeds to step S108.

In step S106, the CPU 30A reads sub-job-related information corresponding to the selected job rule set from the storage unit 34 and causes the list display region R2 to display the information.

In step S108, the CPU 30A determines whether or not at least one job is selected from the jobs displayed in the list display region R2, that is, whether or not a checkmark is input to at least one checkbox. If at least one job is selected, the processing proceeds to step S110. If not a single job is selected, the processing proceeds to step S126.

In step S110, the CPU 30A determines whether or not multiple sub jobs are selected. Specifically, in a case where a job rule set is selected in the job-rule selection region R1 and a list of sub jobs is displayed in the list display region R2, the CPU 30A determines whether or not multiple sub jobs are selected. If multiple jobs are selected, the processing proceeds to step S112. If a single job is selected, the processing proceeds to step S120.

In step S112, the CPU 30A determines whether or not the multiple selected jobs have different output conditions. A case where the multiple sub jobs have different output conditions refers to a case where the output conditions of the multiple sub jobs are not entirely identical, that is, a case where at least two sub jobs have different output conditions. If the multiple selected jobs have different output conditions, the processing proceeds to step S114. If the multiple selected jobs have identical output conditions, the processing proceeds to step S120.

In step S114, the CPU 30A performs control so as not to accept a collective output command for business form data of the multiple selected jobs. In detail, for example, the output command button B6 is displayed in a grayed-out mode, thereby prohibiting a collective output command for multiple pieces of business form data. Moreover, a prohibition flag indicating whether collective output is in a disabled mode or an enabled mode is set to an ON mode. At the start of this routine, the prohibition flag is set to an OFF mode.

In step S116, the CPU 30A determines whether or not a command is given for changing the output conditions of the multiple selected sub jobs to any one of the output conditions of the multiple sub jobs. If a command for changing the output conditions is given, the processing proceeds to step S118. If a command for changing the output conditions is not given, the processing proceeds to step S122.

In step S118, the CPU 30A changes all the output conditions of the multiple selected sub jobs to the output condition corresponding to the change command. For example, as shown in FIG. 9, in a case where multiple sub jobs with “download” and “linkage destination 1” as the set output destinations are selected, if a command for changing the output destinations to “download” is given, the output destinations for the multiple selected sub jobs are all changed to “download”.

In step S120, the CPU 30A performs control so as to accept a collective output command for the business form data of the multiple selected jobs. In detail, for example, if the output command button B6 is displayed in a grayed-out non-clickable mode, the grayed-out mode is canceled, thereby allowing a collective output command. Moreover, the prohibition flag is set to the OFF mode.

In step S122, the CPU 30A determines whether or not the output command button B6 is clicked. If the output command button B6 is clicked, the processing proceeds to step S124. If the output command button B6 is not clicked, the processing proceeds to step S126.

In step S124, the CPU 30A executes an output process. Specifically, the business form data of the selected jobs is output to the output destination designated as an output condition.

In step S126, it is determined whether or not a command for terminating the output process of the business form data is given. For example, it is determined whether or not another button is clicked. Then, if a command for terminating the output process of the business form data is given, the routine ends. If a command for terminating the output process of the business form data is not given, the processing proceeds to step S100 to repeat the above-described process until a termination command is given.

As described above, in the information processing apparatus 20 according to this exemplary embodiment, if multiple sub jobs with different output conditions are selected, the output command button B6 is controlled so as to be displayed in a non-clickable mode, thereby preventing business form data in a condition not processable by a system at an output destination from being output thereto.

As an alternative to this exemplary embodiment in which the information processing program 34A is installed in the storage unit 34, the information processing program 34A according to this exemplary embodiment may be provided by being stored in a computer readable storage medium. For example, the information processing program 34A according to this exemplary embodiment may be provided by being stored in an optical disk, such as a compact disc read-only memory (CD-ROM) or a digital versatile disc read-only memory (DVD-ROM), or by being stored in a semiconductor memory, such as a universal serial bus (USB) memory or a memory card. As another alternative, the information processing program 34A according to this exemplary embodiment may be acquired from an external device via a communication line connected to the communication unit 32.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
perform control for not accepting a collective output command with respect to a plurality of pieces of business form data having different preset output conditions, each piece of business form data being obtained by reading a business form having a predetermined item filled in with information.

2. The information processing apparatus according to claim 1, wherein the processor is configured to perform control for prohibiting pressing of an output command button in a screen that accepts an output command for the business form data, the output command button being used for inputting a command for outputting the business form data.

3. The information processing apparatus according to claim 2, wherein the processor is configured to perform control for graying out the output command button.

4. The information processing apparatus according to claim 1, wherein the processor is configured to:
accept a change to any one of a plurality of different output conditions; and
change the output conditions of the plurality of pieces of business form data to the accepted output condition.

5. The information processing apparatus according to claim 2, wherein the processor is configured to:
accept a change to any one of a plurality of different output conditions; and
change the output conditions of the plurality of pieces of business form data to the accepted output condition.

6. The information processing apparatus according to claim 3, wherein the processor is configured to:
accept a change to any one of a plurality of different output conditions; and
change the output conditions of the plurality of pieces of business form data to the accepted output condition.

7. A non-transitory computer readable medium storing a program causing a computer to execute a process for processing information, the process comprising:
performing control for not accepting a collective output command with respect to a plurality of pieces of business form data having different preset output conditions, each piece of business form data being obtained by reading a business form having a predetermined item filled in with information.

8. An information processing apparatus comprising:
processing means for performing control for not accepting a collective output command with respect to a plurality of pieces of business form data having different preset output conditions, each piece of business form data being obtained by reading a business form having a predetermined item filled in with information.
